(19) United States
(12) Patent Application Publication
(10) Pub. No.: US 2026/0065195 A1
(43) Pub. Date: Mar. 5, 2026

(54) SYSTEMS AND METHODS FOR A TASK PROCESSING DASHBOARD

(71) Applicant: Truist Bank, Charlotte, NC (US)

(72) Inventors: Logendran Kannuthurai, Charlotte, NC (US); Taylor Aycock, Charlotte, NC (US)

(73) Assignee: Truist Bank, Charlotte, NC (US)

(21) Appl. No.: 18/822,139

(22) Filed: Aug. 31, 2024

(51) Int. Cl. G06Q 10/0631

(52) U.S. Cl. CPC G06Q 10/06316

(57) ABSTRACT

A method, computer program product, and computer system for monitoring a plurality of interdependent tasks, wherein the plurality of interdependent tasks includes tasks from different software applications including, but not limited to, client applications and enterprise applications. A workflow of the plurality of interdependent tasks may be controlled to. A workflow of the plurality of interdependent tasks may be controlled to ensure the plurality of interdependent tasks run in a correct sequence. It may be determined that a task among the plurality of interdependent tasks has failed to complete. An action may be executed based upon, at least in part, determining that the task among the plurality of interdependent tasks has failed to complete.

### TECHNICAL FIELD

The present disclosure relates to processing computer tasks, and more particularly, to processing, handling, and monitoring of interdependent computer tasks of various technologies.

### BACKGROUND

A computer-based task or job involves using one or more computers to perform specific activities or functions, often requiring interaction with software applications. These tasks can range from, e.g., data entry, programming, graphic design, and digital marketing, to more complex functions like data analysis, financial modeling, and software development. Regardless of the application or the task/job being performed, it may be beneficial to track the status of each task/job.

### SUMMARY

In one example implementation, a computer-implemented method, performed by one or more computing devices, may include but is not limited to monitoring a plurality of interdependent tasks, wherein the plurality of interdependent tasks includes tasks from different software applications including, but not limited to, client applications and enterprise applications. A workflow of the plurality of interdependent tasks may be controlled to ensure the plurality of interdependent tasks run in a correct sequence. It may be determined that a task among the plurality of interdependent tasks has failed to complete. An action may be executed based upon, at least in part, determining that the task among the plurality of interdependent tasks has failed to complete.

One or more of the following example features may be included. Executing the action may include sending an electronic notification that the task among the plurality of interdependent tasks has failed to complete. The electronic notification may be an electronic mail notification. Executing the action may include preventing at least one additional task among the plurality of interdependent tasks from running. A dashboard with data and information associated with the plurality of interdependent tasks may be rendered. The data and information may include status report data and information. The data and information may include a jobID, a dependencyID, one of a success and failure, and an explanation of the failure.

In another example implementation, a computing system may include one or more processors and one or more memories configured to perform operations that may include but are not limited to monitoring a plurality of interdependent tasks, wherein the plurality of interdependent tasks includes tasks from different software applications. A workflow of the plurality of interdependent tasks may be controlled to ensure the plurality of interdependent tasks run in a correct sequence. It may be determined that a task among the plurality of interdependent tasks has failed to complete. An action may be executed based upon, at least in part, determining that the task among the plurality of interdependent tasks has failed to complete.

One or more of the following example features may be included. Executing the action may include sending an electronic notification that the task among the plurality of interdependent tasks has failed to complete. The notification may be an electronic mail notification. Executing the action may include preventing at least one additional task among the plurality of interdependent tasks from running. A dashboard with data and information associated with the plurality of interdependent tasks may be rendered. The data and information may include status report data and information. The data and information may include a jobID, a dependencyID, one of a success and failure, and an explanation of the failure.

In another example implementation, a computer program product may reside on a computer readable storage medium having a plurality of instructions stored thereon which, when executed across one or more processors, may cause at least a portion of the one or more processors to perform operations that may include but are not limited to monitoring a plurality of interdependent tasks, wherein the plurality of interdependent tasks includes tasks from different software applications. A workflow of the plurality of interdependent tasks may be controlled to ensure the plurality of interdependent tasks run in a correct sequence. It may be determined that a task among the plurality of interdependent tasks has failed to complete. An action may be executed based upon, at least in part, determining that the task among the plurality of interdependent tasks has failed to complete.

One or more of the following example features may be included. Executing the action may include sending an electronic notification that the task among the plurality of interdependent tasks has failed to complete. The notification may be an electronic mail notification. Executing the action may include preventing at least one additional task among the plurality of interdependent tasks from running. A dashboard with data and information associated with the plurality of interdependent tasks may be rendered. The data and information may include status report data and information. The data and information may include a jobID, a dependencyID, one of a success and failure, and an explanation of the failure.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### DRAWINGS

FIG. 1 is an example diagrammatic view of a task process coupled to an example distributed computing network according to one or more example implementations of the disclosure;

FIG. 2 is an example diagrammatic view of a computing device of FIG. 1 according to one or more example implementations of the disclosure;

FIG. 3 is an example flowchart of a task process according to one or more example implementations of the disclosure;

FIG. 4 is an example diagrammatic view of an example computing network according to one or more example implementations of the disclosure; and

FIG. 5 is an example diagrammatic view of dashboard according to one or more example implementations of the disclosure.

Like reference symbols in the various drawings indicate like elements.

### DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to Al, or to one or more examples of Al, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

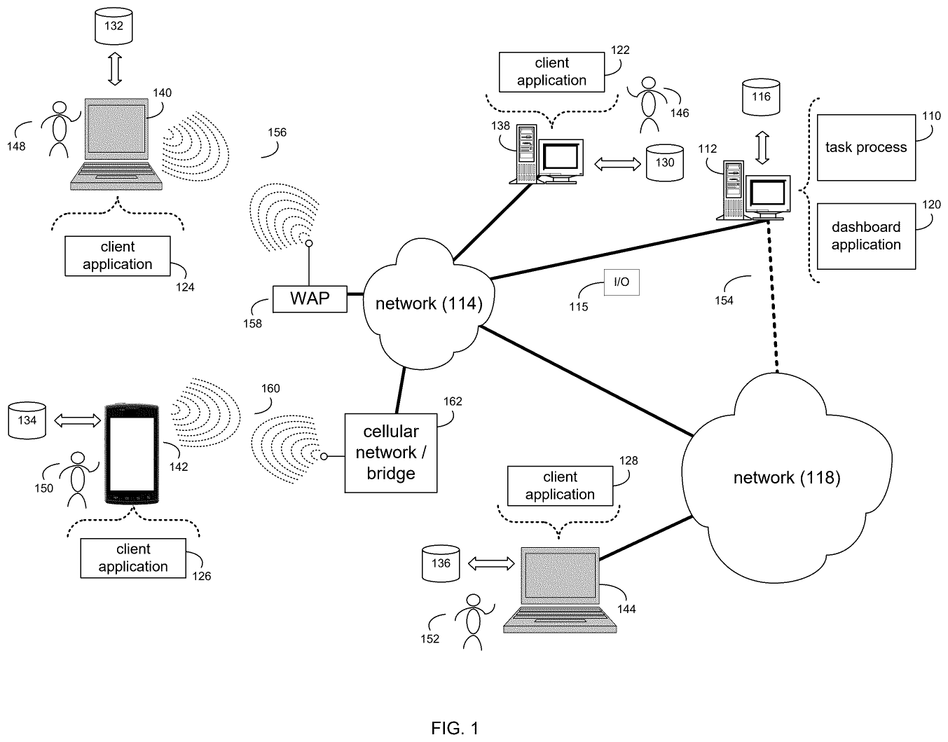

Referring now to the example implementation of FIG. 1, there is shown task process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a task process, such as task process 110 of FIG. 1, may monitor a plurality of interdependent tasks, wherein the plurality of interdependent tasks includes tasks from different software applications. A workflow of the plurality of interdependent tasks may be controlled to ensure the plurality of interdependent tasks run in a correct sequence. It may be determined that a task among the plurality of interdependent tasks has failed to complete. An action may be executed based upon, at least in part, determining that the task among the plurality of interdependent tasks has failed to complete.

In some implementations, the instruction sets and subroutines of task process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, task process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a dashboard application (e.g., dashboard application 120), examples of which may include, but are not limited to, e.g., a system monitoring dashboard, a job scheduling dashboard, an ETL and data integration dashboard, an application performance monitoring (APM) dashboard, a custom dashboard, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for monitoring and/or displaying of monitored task data and information. [In some implementations, task process 110 and/or dashboard application 120 may be accessed via one or more of client applications 122, 124, 126, 128. In some implementations, task process 110 may be a standalone application, or may be an applet/application/script/extension that may interact with and/or be executed within dashboard application 120, a component of dashboard application 120, and/or one or more of client applications 122, 124, 126, 128. In some implementations, dashboard application 120 may be a standalone application, or may be an applet/application/script/extension that may interact with and/or be executed within task process 110, a component of task process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of task process 110 and/or dashboard application 120. Examples of client applications 122, 124, 126, 128 may include, but are not limited to, e.g., a VR application, XR or MR application, an AR application, a system monitoring dashboard, a job scheduling dashboard, an ETL and data integration dashboard, an application performance monitoring (APM) dashboard, a custom dashboard, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for monitoring and/or displaying of monitored task data and information, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of task process 110 (and vice versa). Accordingly, in some implementations, task process 110 may be a purely server-side application, a purely client-side application, or a hybrid server-side/client-side application that is cooperatively executed by one or more of client applications 122, 124, 126, 128 and/or task process 110.

In some implementations, one or more of client applications 122, 124, 126, 128 may be configured to effectuate some or all of the functionality of dashboard application 120 (and vice versa). Accordingly, in some implementations, dashboard application 120 may be a purely server-side application, a purely client-side application, or a hybrid server-side/client-side application that is cooperatively executed by one or more of client applications 122, 124, 126, 128 and/or dashboard application 120. As one or more of client applications 122, 124, 126, 128, task process 110, and dashboard application 120, taken singly or in any combination, may effectuate some or all of the same functionality, any description of effectuating such functionality via one or more of client applications 122, 124, 126, 128, task process 110, dashboard application 120, or combination thereof, and any described interaction(s) between one or more of client applications 122, 124, 126, 128, task process 110, dashboard application 120, or combination thereof to effectuate such functionality, should be taken as an example only and not to limit the scope of the disclosure.

In some implementations, one or more of users 146, 148, 150, 152 may access computer 112 and task process 110 (e.g., using one or more of client electronic devices 138, 140, 142, 144) directly through network 114 or through network 118. Further, computer 112 may be connected to network 114 through network 118, as illustrated with phantom link line 154. Task process 110 may include one or more user interfaces, such as browsers and textual or graphical user interfaces, through which users 146, 148, 150, 152 may access task process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (Saas), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken data and information from a user and convert it to usable digital data and information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

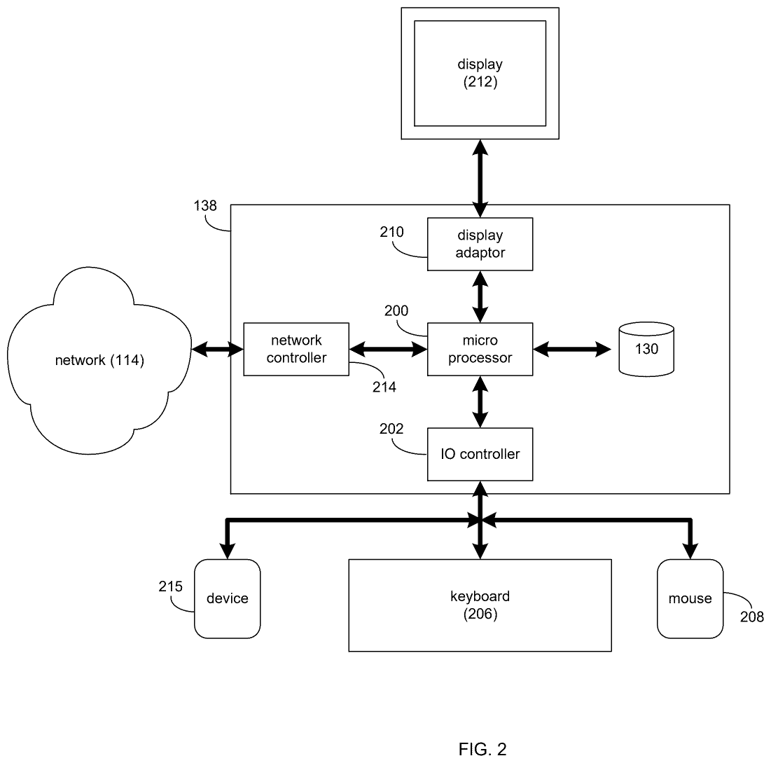

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, task process 110 may be substituted for client electronic device 138 (in whole or in part) within FIG. 2, examples of which may include but are not limited to computer 112 and/or one or more of client electronic devices 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

A computer-based task or job involves using one or more computers to perform specific activities or functions, often requiring interaction with software applications. These tasks can range from, e.g., data entry, programming, graphic design, and digital marketing, to more complex functions like data analysis, financial modeling, and software development. A task typically refers to a specific unit of work or a process that a computer program performs. Tasks are often smaller, discrete operations that can be executed independently or as part of a larger process. For example, a task might involve fetching data from a database, processing an input, or rendering a graphical element. Tasks can be managed by the operating system or a task scheduler and can run concurrently with other tasks. A job, on the other hand, is usually a larger, more comprehensive unit of work that can encompass multiple tasks. Jobs are often scheduled and managed by a job scheduler or batch processing system. For instance, a job might involve a series of tasks like data extraction, transformation, loading (ETL), and generating reports. Jobs are typically more complex and may require orchestrating several tasks in a specific sequence to achieve a desired outcome. Regardless of the application or the task/job being performed, it may be beneficial to track the status of each task/job.

There are techniques to track the status with tasks that are specific to one technology (environment). For example, Windows jobs may be described generally as tasks or sets of tasks (jobs) scheduled to run on a Windows operating system. Windows Task Scheduler is a tool that allows users to create and manage these jobs, which can include running applications, scripts, or commands at specified times or in response to specific events. Windows jobs are often used for system maintenance, automated backups, and routine administrative tasks. As another example Enterprise Scheduling and Planning (ESP) jobs may generally be described as tasks/jobs scheduled and managed by enterprise scheduling software. This software is typically used in large organizations to automate and streamline the execution of complex job schedules. ESP jobs can include tasks like data processing, application execution, and report generation, ensuring that workflows are efficiently coordinated. As yet another example, SQL Server Integration Services (SSIS) jobs may generally be described as tasks managed by a SQL Server Agent within the Microsoft SQL Server environment. SSIS is a data integration and workflow tool used for data migration, Extract, Transform, Load (ETL) processes, and data warehousing. SSIS jobs typically involve running SSIS packages, which are collections of tasks designed to move and transform data between databases, files, and other data sources. SQL Server Agent schedules and executes these jobs to automate data processing workflows. Each of these job types serves a specific purpose within their respective environments, helping to automate and manage various tasks and workflows efficiently.

Notably, there is no singular solution that brings in many different job/task technologies (e.g., Windows jobs, ESP jobs, SSIS jobs, etc.) under one process. They generally do not work with such a wide range of technologies and cannot coordinate tasks of different technologies to work together. Therefore, as will be discussed in greater detail below, the present disclosure describes implementations to more easily handle and monitor interdependent tasks and jobs of various technologies. The present disclosure enables the control of the workflow of interdependent jobs to ensure that they run in the correct sequence and that, in the event of any failure, the workflow will halt and notifications will be sent. More particularly, the present disclosure describes a centralized solution, enabling multiple jobs from multiple technologies may communicate and coordinate the task workflows, as well as provide status reports and send notifications.

Thus, there is described a single platform where a user may monitor the status of all tasks (regardless of technology) and may view status reports. In some implementations, the single platform may also provide safeguards to prevent tasks from running out of order and to prevent further complications if any single job has a failure.

As will be discussed below, task process 110 may at least help, e.g., improve task management technology, necessarily rooted in computer technology, in order to overcome an example and non-limiting problem specifically arising in the realm of computer task processing with, e.g., multiple jobs from multiple technologies. It will be appreciated that the computer processes described throughout are integrated into one or more practical applications, and when taken at least as a whole are not considered to be well-understood, routine, and conventional functions.

### The Task Process:

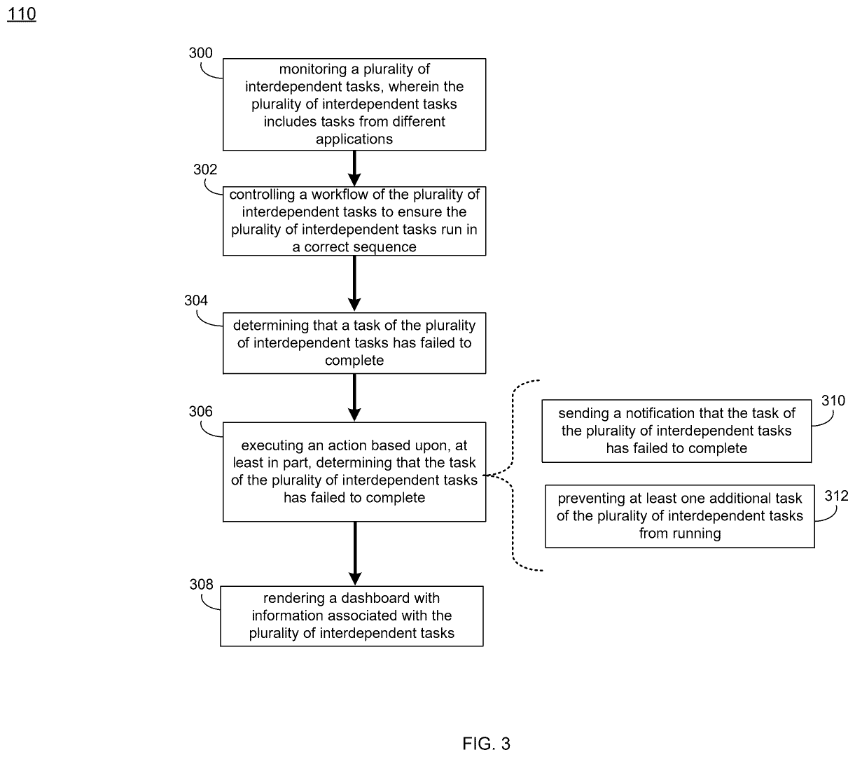

As discussed above and referring also at least to the example implementations of FIGS. 3-5, task process 110 may monitor 300 a plurality of interdependent tasks, wherein the plurality of interdependent tasks includes tasks from different software applications. Task process 110 may control 302 a workflow of the plurality of interdependent tasks to ensure the plurality of interdependent tasks run in a correct sequence. Task process 110 may determine 304 that a task among the plurality of interdependent tasks has failed to complete. Task process 110 may execute 306 an action based upon, at least in part, determining that the task among the plurality of interdependent tasks has failed to complete.

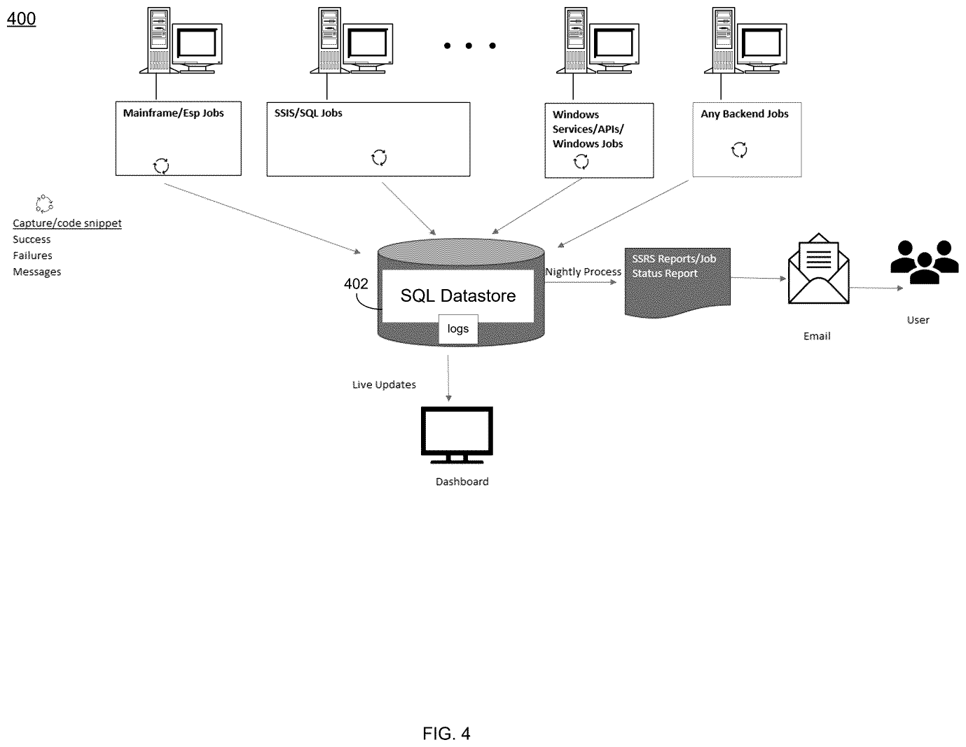

In some implementations, task process 110 may monitor 300 a plurality of interdependent tasks, wherein the plurality of interdependent tasks includes tasks from different software applications. For example, and referring at least to the example implementation of FIG. 4, an example alternative view of one or more aspects of the distributed computing network of FIG. 1 is shown. In the example, computing environment 400 shows datastore 402 (e.g., a SQL datastore), which may store some or all of the data and information needed to monitor and report data associated with the plurality of tasks/jobs. For ease of explanation, as used herein, the terms “job” and “task” may be used interchangeably. In some implementations, monitoring interdependent computer tasks may involve a multifaceted approach to ensure that multiple related processes work together seamlessly to achieve a common objective. This may include real-time monitoring and alerts, dependency tracking, logging and auditing, performance metrics and analytics, job scheduling and management, and integration and data flow monitoring, as will be discussed further below. Notably, the different software applications are able to work together, since task process 110 is the “master” process that controls everything. Task process 110 exposes the API and database endpoints that each application makes calls to. When initializing a new task, each application will call an endpoint of task process 110 in order to get the go-ahead to proceed. After that, there are other endpoints that the application can use to report progress and to report success/failure. This also gives the flexibility to change application dependencies on the fly in task process 110, as it is controlled there instead of each application having to know about the dependencies. Other task schedulers typically do not give this flexibility, and sequential tasks generally must be packaged together in one multi-task package, and to change something, one must change the whole package. It will be appreciated after reading the present disclosure that various other job types and/or computing device may be used without departing from the scope of the present disclosure. As such, the configuration shown in FIG. 4 should be taken as example only and not to otherwise limit the scope of the present disclosure.

For instance, task process 110 may monitor a web server environment, tracking the status of web services and server health. If a critical service like HTTP or MySQL fails, task process 110 may immediately send alerts via email or SMS or other means to the administrator, enabling quick response and minimizing downtime. For dependency tracking, task process 110 may, e.g., in a data processing pipeline, tasks such as data extraction, transformation, and loading (ETL) are interdependent. Task process 110 may visualize these dependencies, ensuring that data transformation starts only after data extraction completes successfully. If the extraction task fails, the transformation task may be paused until the issue is resolved.

In some implementations, task process 110 may store all of the above data and information to maintain detailed logs of an application's performance. For instance, task process 110 may store logs of user activities and system errors, process and filter these logs, and visualize them (e.g., render them on a computer display). This setup helps identify issues like frequent login failures, allowing for quick diagnostics and remedial actions. In some implementations, task process 110 may monitor the performance of a network infrastructure by tracking metrics such as bandwidth usage, server response times, and application performance. By analyzing these metrics, IT professionals can identify performance bottlenecks, like a server consistently operating at high CPU usage, and optimize the system accordingly.

In some implementations, task process 110 may control 302 a workflow of the plurality of interdependent tasks to ensure the plurality of interdependent tasks run in a correct sequence. For instance, in some implementations, task process 110 may schedule end-of-day batch processing jobs. These jobs may involve generating daily reports, updating transaction records, and performing backups. Task process 110 may ensure these tasks execute in the correct sequence and within specified time windows, balancing the workload to avoid resource conflicts. Additionally, task process 110 integrate multiple business applications. For example, task process 110 may ensure data flows seamlessly from a CRM system to an email marketing platform. Task process 110 may monitor these data flows, tracking integration points and API calls. If an API fails, task process 110 may log the error and retry the operation, ensuring data consistency across systems.

Ensuring that interdependent tasks execute in the correct sequence and within specified time windows may involve a combination of scheduling, dependency management, monitoring, and verification. Task process 110 may use a scheduler to allow for precise timing of task execution, ensuring tasks start at designated times. Task process 110 may use a workflow orchestration tool to manage task dependencies by defining sequences in which tasks must execute, guaranteeing that dependent tasks only start once their prerequisites are completed. As an example, task process 110 may enable condition-based execution, triggering tasks only when specific conditions are met. As noted above, task process 110 may continuously oversee task status and issue alerts if tasks fail or exceed their time windows, enabling prompt corrective action.

In some implementations, task process 110 may determine 304 that a task among the plurality of interdependent tasks has failed to complete. For instance, task process 110 may provide detailed logs that offer an audit trail of task executions, including timestamps and status data and information. This detailed logging is beneficial for verification, as it allows administrators to track the exact order and timing of task completions. By examining these logs, it may be confirmed that each task was executed in the correct sequence. In some implementations, task process 110 may include a retry mechanism and error handling feature to automatically retry failed tasks based on predefined rules, ensuring temporary issues do not disrupt workflows. In some implementations, task process 110 may include resource management features in its job scheduler and/or cloud orchestration platforms to ensure that tasks have the necessary resources for timely execution by allocating additional CPU or memory as needed. By integrating these techniques and tools, task process 110 maintains the integrity and efficiency of complex workflows, verifying that tasks execute in the correct sequence and as planned.

However, it is possible that a particular task has failed to complete (e.g., failed to execute, failed to begin, failed to complete, etc.). For instance, determining that a task has failed may involve one or more mechanisms and criteria, depending on the tools and systems in use. For instance, task process 110 may check exit codes and return values, since many tasks and scripts may return an exit code upon completion, with zero indicating success and non-zero indicating failure. Additionally, tasks often generate error messages or logs when they fail, and task process 110 may parse these logs to identify failure patterns. Timeouts are another indicator that may be used by task process 110. If a task takes longer than a predefined maximum time to complete, it is considered failed. Health checks and heartbeats may also be used by task process task process 110, where periodic signals verify that a task is still running properly; failure to receive these signals within a specified interval marks the task as failed. As another example, tasks involving API calls or external services may fail if responses return specific error status codes, such as a “500 Internal Server Error.” It will be appreciated that different or even custom defined failure conditions may be used based on business logic or specific criteria (e.g., fail if a number of records processed is below a certain threshold). In these examples, task process 110 may update the logs and dashboard to reflect the failures, as discussed below.

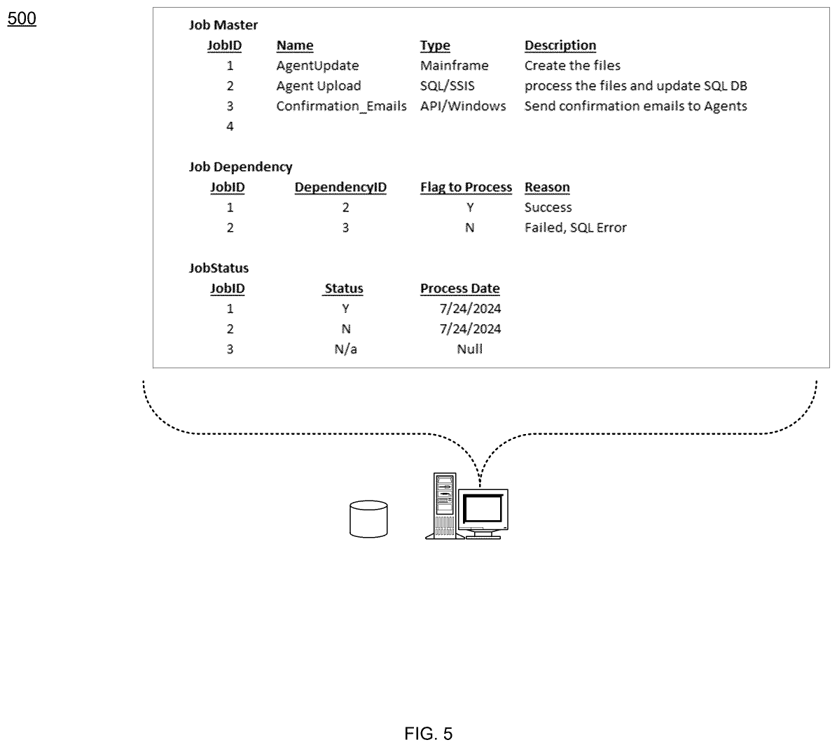

In some implementations, task process 110 may render 308 a dashboard with data and information associated with the plurality of interdependent tasks, where in some implementations, the data and information may include status report data and information, a jobID, a dependencyID, one of a success and failure, and an explanation of the failure. For instance, and referring at least to the example implementation of FIG. 5, an example dashboard (e.g., dashboard 500) is shown. In the illustrated example, the data and information may be retrieved from datastore 402. As shown in FIG. 5, dashboard 500 may include a JobID that identifies each job, the name of the job, the type of job, and a description of the job. Another portion of dashboard 500 may include the job dependencies. For instance, dashboard 500 may include the JobID, a Dependency ID denoting the subsequent task(s) that will rely upon current task being completed, a flag or other indicator denoting whether to process the task, and a reason/explanation for any failure. Another portion of dashboard 500 may include job status. For instance, dashboard 500 may include the JobID, the status (e.g., yes, no, pass, failed, etc.) as well as the process date/time when the task was processed. It will be appreciated after reading the present disclosure that more or less data fields may be used without departing from the scope of the present disclosure. As such, the dashboard configuration shown in FIG. 5 should be taken as example only and not to otherwise limit the scope of the present disclosure.

In some implementations, task process 110 may execute 306 an action based upon, at least in part, determining that the task among the plurality of interdependent tasks has failed to complete. For instance, as can be seen from FIG. 5, job 2 has failed, causing task process 110 to trigger the SSRS/notification. In some implementations, executing the action may include sending 310 an electronic notification that the task among the plurality of interdependent tasks has failed to complete. For instance, the electronic notification may be an electronic mail (email) notification, a text message notification, a pop-up notification, an audible notification, and/or any other type of notification, denoting that job 2 has failed.

In some implementations, executing the action may include preventing 312 at least one additional task among the plurality of interdependent tasks from running. For instance, to prevent a task from running when it depends on a failed task, task process 110 may use a combination of dependency management and coordination mechanisms. For example, task process 110 may use a workflow orchestration tool, which allows explicit definition of dependencies, organizing tasks in Directed Acyclic Graphs (DAGs) where each node represents a task and edges represent dependencies. This ensures that dependent tasks do not start if their predecessors fail. As noted above, task process 110 may also include scheduling and orchestration tools that support conditional execution, enabling tasks to run only if specific conditions, like the success of preceding tasks, are met. For example, task process 110 may implement a pipeline to run subsequent jobs only upon the success of previous ones. Error propagation mechanisms further ensure that a failure status is communicated throughout the system, halting dependent tasks automatically. Task process 110 may use a so-called “fail-fast” mechanism that immediately stops the execution of dependent tasks when an upstream task fails. Retry and error handling policies may also be used by task process 110 to specify actions to take upon task failure, including not proceeding with dependent tasks until retries or error resolutions are exhausted. In event-driven architectures, tasks trigger one another upon successful completion. If a task fails, it does not emit a success event, hence dependent tasks are not triggered.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, comprising:
monitoring, by a computing device, a plurality of interdependent tasks that includes tasks from different software applications;
controlling, by the computing device, a workflow of the plurality of interdependent tasks to ensure the plurality of interdependent tasks run in a correct sequence;
determining, by the computing device, that a task among the plurality of interdependent tasks has failed to complete; and
executing, by the computing device, an action based upon, at least in part, a determination that the task among the plurality of interdependent tasks has failed to complete.

2. The computer-implemented method of claim 1, wherein executing the action includes sending an electronic notification that the task among the plurality of interdependent tasks has failed to complete.

3. The computer-implemented method of claim 2, wherein the electronic notification is an electronic mail notification.

4. The computer-implemented method of claim 1, wherein executing the action includes preventing at least one additional task among the plurality of interdependent tasks from running.

5. The computer-implemented method of claim 1, further comprising rendering, by the computing device, a dashboard with data and information associated with the plurality of interdependent tasks.

6. The computer-implemented method of claim 5, wherein the data and information includes status report data and information.

7. The computer-implemented method of claim 6, wherein the data and information includes a jobID, a dependencyID, one of a success and failure, and an explanation of the failure.

8. A computer program product residing on a computer readable storage medium having a plurality of instructions stored thereon which, when executed across one or more processors, causes at least a portion of the one or more processors to perform operations comprising:
monitoring, by a computing device, a plurality of interdependent tasks that includes tasks from different software applications;
controlling, by the computing device, a workflow of the plurality of interdependent tasks to ensure the plurality of interdependent tasks run in a correct sequence;
determining, by the computing device, that a task among the plurality of interdependent tasks has failed to complete; and
executing, by the computing device, an action based upon, at least in part, a determination that the task among the plurality of interdependent tasks has failed to complete.

9. The computer program product of claim 8, wherein executing the action includes sending an electronic notification that the task among the plurality of interdependent tasks has failed to complete.

10. The computer program product of claim 9, wherein the electronic notification is an electronic mail notification.

11. The computer program product of claim 8, wherein executing the action includes preventing at least one additional task among the plurality of interdependent tasks from running.

12. The computer program product of claim 8, wherein the instructions further comprise rendering a dashboard with data and information associated with the plurality of interdependent tasks.

13. The computer program product of claim 12, wherein the data and information includes status report data and information.

14. The computer program product of claim 13, wherein the data and information includes a jobID, a dependencyID, one of a success and failure, and an explanation of the failure.

15. A computing system including one or more processors and one or more memories configured to perform operations comprising:
monitoring, by a computing device, a plurality of interdependent tasks that includes tasks from different software applications;
controlling, by the computing device, a workflow of the plurality of interdependent tasks to ensure the plurality of interdependent tasks run in a correct sequence;
determining, by the computing device, that a task among the plurality of interdependent tasks has failed to complete; and
executing, by the computing device, an action based upon, at least in part, a determination that the task among the plurality of interdependent tasks has failed to complete.

16. The computing system of claim 15, wherein executing the action includes sending an electronic notification that the task among the plurality of interdependent tasks has failed to complete.

17. The computing system of claim 15, wherein executing the action includes preventing at least one additional task among the plurality of interdependent tasks from running.

18. The computing system of claim 15, wherein the instructions further comprise rendering a dashboard with data and information associated with the plurality of interdependent tasks.

19. The computing system of claim 19, wherein the data and information includes status report data and information.

20. The computing system of claim 20, wherein the data and information includes a jobID, a dependencyID, one of a success and failure, and an explanation of the failure.
